(19) United States
(12) Patent Application Publication
(10) Pub. No.: US 2010/0161447 A1
(43) Pub. Date: Jun. 24, 2010

(54) METHOD AND SYSTEM FOR PROVIDING DESIGN LAW RESOURCE CENTER

(76) Inventors: Perry J. Saidman, Silver Spring, MD (US); Danton A. Neagle, Allentown, PA (US)

Correspondence Address: CHRISTOPHER PAUL MITCHELL, 888 16TH ST., NW, SUITE 800, WASHINGTON, DC, 20006, US

(21) Appl. No.: 12/370,590

(22) Filed: Feb. 12, 2009

Related U.S. Application Data
(63) Continuation of application No. 10/922,474, filed on Aug. 19, 2004.
Application No. 10/922,474 is a continuation-in-part of application No. 09/772,302, filed on Jan. 29, 2001, now abandoned.
(60) Provisional application No. 60/178,586, filed on Jan. 28, 2000.

(51) Int. Cl. G06Q 50/00; G06Q 30/00; G06Q 10/00; G06F 17/30

(52) U.S. Cl. 705/27; 705/400; 707/E17.044; 707/E17.107

(57) ABSTRACT

An internet website providing information, services and products relating to legal issues (e.g., intellectual property protection) for various types of designs, including industrial design, graphic design, architectural design, art design, and the like. The website is preferably located at the internet domain URL www.designlaw.com.

The website serves as a resource for anyone interested in the interplay between the law and design. The target audience includes designers, attorneys having design-related practices, and others interested in learning more about designs and protecting them with intellectual property rights. It will also cover basic legal concepts involving designs, such as who owns designs, contracts between designers and companies, and the like.

In a preferred embodiment, one of the products/services offered through the website is a database of images of products and designs involved in design law litigation, such as design patent litigation. Such images would include, for example, images of the patented designs and the accused designs, and would be offered on a fee per case basis, or a subscription basis. The case data can also include the actual court decision, a summary of the case, and an expert commentary. Users can search the database based on selected criteria, such as date, legal issue, court, type of design, and the like.

### CROSS-REFERENCE TO RELATED APPLICATIONS

This application is a continuation of U.S. patent application Ser. No. 10/922,474, filed Aug. 19, 2004, which is a continuation-in-part of U.S. patent application Ser. No. 09/772,302, filed Jan. 29, 2001, which in turn claims priority from U.S. Provisional Application No. 60/178,586, filed Jan. 28, 2000, all of which are incorporated herein by reference.

### BRIEF SUMMARY

The invention comprises an internet website providing information, services and products relating to legal issues (e.g., intellectual property protection) for designs. The types of designs can include industrial design, graphic design, architectural design, art design, and the like. The website will preferably be located at the internet domain URL www.designlaw.com.

The primary purpose of the website is to serve as a resource for anyone interested in the interplay between the law and design. The target audience will include designers, attorneys having design-related practices, and others interested in learning more about designs and protecting them with intellectual property rights. It will also cover basic legal concepts involving designs, such as who owns designs, contracts between designers and companies, and the like. Collectively, the interplay between design and the law will be referred to hereinafter as “design law”.

More particularly, a preferred embodiment of the present invention comprises an e-commerce method that allows end users who are attorneys, designers, judges, librarians, or even members of the general public, to access a database that stores critical information relating to design law litigation. Critical information of the type contemplated by the present invention has not been previously gathered or made available in an easy-to-access single source. The critical information is stored in a database that can be accessed by end users through the internet. Even more particularly, the critical information comprises visual images of products involved in design-related cases, such as design patent litigations.

### BRIEF DESCRIPTION OF THE DRAWINGS

The foregoing and other aspects of the present invention will become more fully apparent from the following detailed description of the present invention when viewed in conjunction with the accompanying drawings, in which:

FIG. 1 is a schematic diagram of a preferred embodiment of a website according to the present invention;

FIG. 2 is a schematic drawing of a preferred embodiment of an e-commerce method according to the present invention;

FIG. 3 is a schematic diagram showing the five main areas of a database of the preferred e-commerce method of FIG. 2;

FIG. 4 is a flowchart showing interaction of an end user in the e-commerce method of FIG. 2; and

FIG. 5 is a sample web page that would be presented to an e-commerce user/purchaser according to the preferred embodiment of FIG. 2.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

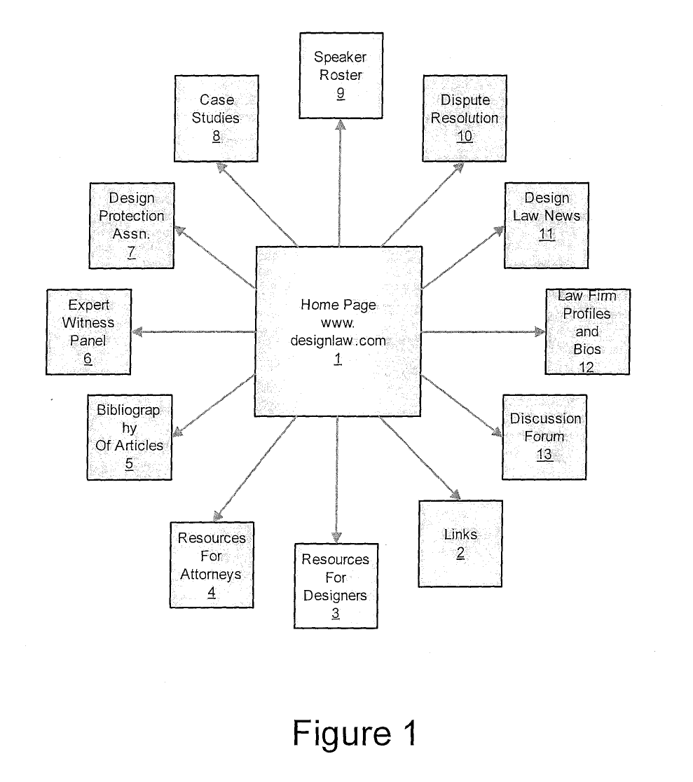

As illustrated in FIG. 1, users of the website would first be directed to a home page 1 which serves as a gateway to the information, products and services offered on the site. The information, products and services available from home page 1 preferably include one or more of the following:
LINKS 2—Links 2 preferably comprise hyperlinks to other websites related to design law, including websites dedicated to: law firms that have one or more specialists in design law, design associations (e.g., Industrial Designers Society of America, Association of Professional Design Firms, etc.), U.S. and foreign patent, trademark and copyright agencies (e.g., USPTO, etc.), and existing laws and legislation (e.g., from the U.S. Congress, etc.). Some of these links could comprise advertisers/vendors of products/services related to design law, who would pay a fee to the website owner for such listing(s).
RESOURCES FOR DESIGNERS 3—This category preferably comprises design law information written for designers relating to legal issues such as intellectual property protection for designs (such information may be offered as a free service or for a fee), patent litigation insurance, etc. This category may also include contact information for “design agents”, i.e., persons (not necessarily attorneys) who offer to represent designers in negotiations with those manufacturers who may be interested in the marketing and sale of products embodying new designs. Such agents could purchase listings from the website owner in order to have their contact information on the website. Finally, it may also include a marketplace for designs where designers can offer to license/sell their new designs to manufacturers. Again, any or all of these products/services may be offered either on a fee basis or for free.
RESOURCES FOR ATTORNEYS 4—This category would preferably provide design law information for attorneys who represent designers including, for example, articles on recent cases involving protection of designs (i.e., design patent cases, trade dress cases, trademark cases involving product configuration trademarks, and copyright cases). Information would also be presented on how to use utility patents to protect designs, and statistics on the effectiveness of litigation, etc. The category could also have a periodic digest of the state of design law.
BIBLIOGRAPHY OF ARTICLES 5—This product/service would comprise a list of articles relating to designs and design law, along with hyperlinks to the text of the articles (which may be offered as a free service or for a fee).
EXPERT WITNESS PANEL 6—This product/service preferably would include contact and bibliographical information for a group of legal and design experts in fields relating to design, including, e.g., design patent law, trade dress law, and industrial design. The website may further offer placement services between such experts and principals (e.g., litigators) for a fee.
DESIGN PROTECTION ASSOCIATION 7—This preferably comprises an association devoted to the protection of designs, mainly by intellectual property (e.g., design patents, utility patents, trade dress, copyright, etc.). The association's activities could include, for example, lobbying for improvements in U.S. and foreign laws relating to design protection, and/or operating a design protection co-operative. The design protection co-operative could, e.g., pool the resources of designers, design firms and companies that might not otherwise have the financial means to pursue infringers of their intellectual property rights. The co-operative, using its aggregate resources, could take court action against an infringer of a member of the cooperative. Criteria for such action would be governed by the association's board of governors.
CASE STUDIES 8—This product would preferably comprise brief presentations of cases and designs of current and/or historical interest, and could be offered on a fee or no-fee basis.
SPEAKER ROSTER 9—This product/service would provide information about people (e.g., designers, lawyers) who are available to speak to legal or designer groups on design law topics.
DISPUTE RESOLUTION 10—This product/service comprises information relating to the resolution of disputes involving designs, including legal remedies, alternative dispute resolution (e.g., mediation, arbitration), and contact information for experts in the field of design dispute resolution. Such alternative dispute resolution could also include neutral expert evaluation, so a party contemplating litigation can get an independent assessment of the strengths and weaknesses of their case.
Current Design Law News 11—This product/service would provide information about current events relating to design law, including new and proposed legislation and regulatory changes, recent court decisions, newly licensed product designs, resolutions of design law disputes, and other events of interest to users of the website.
LAW FIRM PROFILES AND BIBLIOGRAPHIES 12—This product/service would provide information, including profiles and bibliographies, relating to law firms and attorneys who specialize in design law.
DISCUSSION FORUMS 13—This product/service may include chat rooms and bulletin boards where users of the website can communicate with one another about design and design law issues.

The present invention also comprises an e-commerce method that allows end users who are attorneys, designers, judges, librarians, or even members of the general public, to access a database that stores critical information relating to design law litigation. As will become more clear hereinafter, this e-commerce method is a product/service that incorporates certain features and elements described in connection with FIG. 1 above regarding resources for designers 3, resources for attorneys 4, case studies 8, and current design law news 11. The e-commerce method also incorporates several additional features and elements, as will now be described.

Critical information of the type contemplated by the e-commerce method of the present invention has not been previously gathered or made available in an easy-to-access single source. The critical information is stored in a database that can be accessed by end users through the internet. In particular, the critical information comprises visual images of products involved in design-related cases, such as design patent litigations.

By way of background, too often the design law litigation decisions reported in the various court reporters (e.g., Westlaw, LEXIS, BNA's USPQs, etc.) do not include images of either the protected design or the accused design. This makes it difficult, if not impossible, to appreciate the true import of a reported decision, that, as one might expect, depends on the appearance of the protected design and the accused design. This is particularly true for design patent litigations, and is also true for trade dress and copyright litigations. By producing, collecting, and otherwise assembling visual data of the protected design and accused design in a decided design law litigation, the present invention comprises offering such visual images on the website on a fee basis, along with other data relating to the particular case.

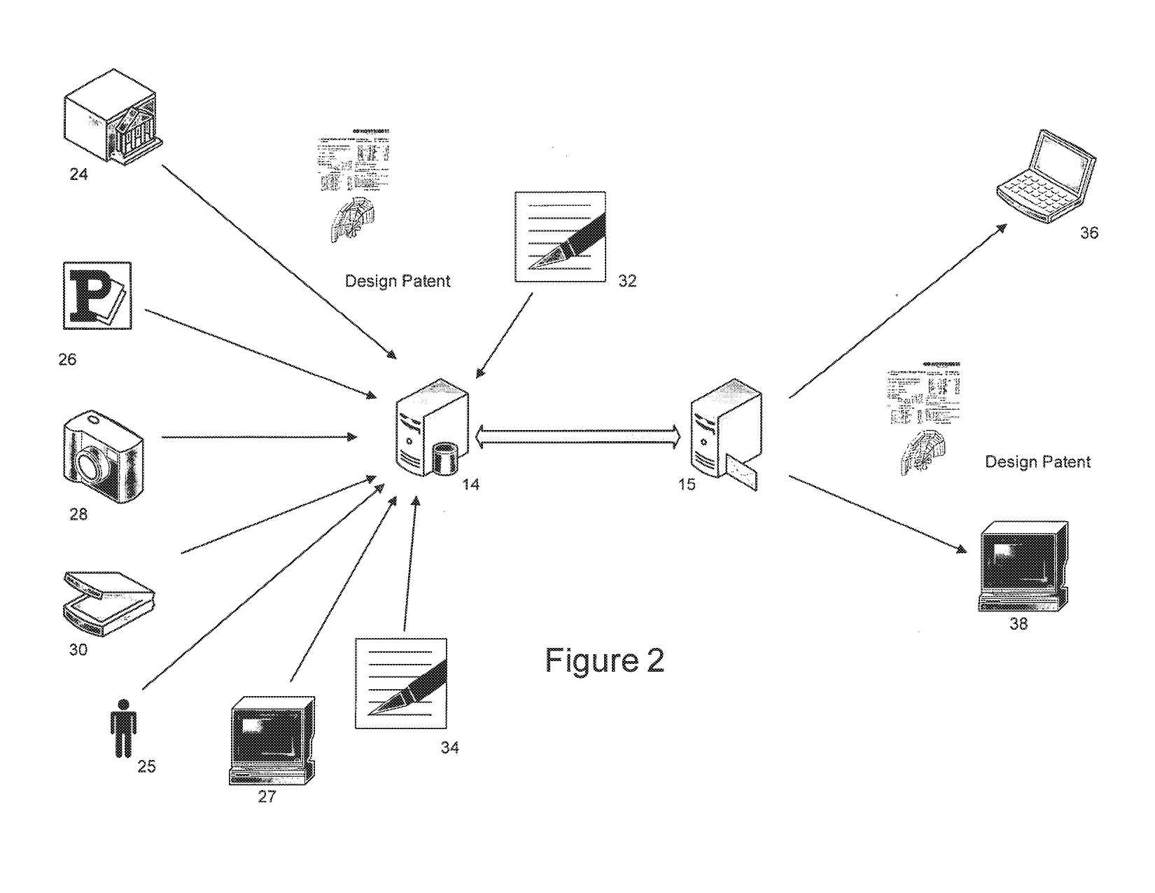

Referring now to FIG. 2, there is shown a schematic diagram of a preferred embodiment of the e-commerce image-retrieval method of the present invention. The method and system contemplates a database server 14 that gathers data from several sources, as will be explained. Database server 14 communicates with an email server 15, in a manner that is well-known in the art, to provide selected data stored in server 14 on demand from end users via their computer terminals represented schematically by laptop 36 and desktop 38.

The preferred embodiment of the e-commerce image-retrieval method of the present invention will be described hereinafter in connection with design patent litigation, although it will be clear that it also can apply to trade dress litigation and copyright litigation (both of which can involve visual images), or any other type of litigation where it is important to a better understanding of the case to view visual images involved in the case.

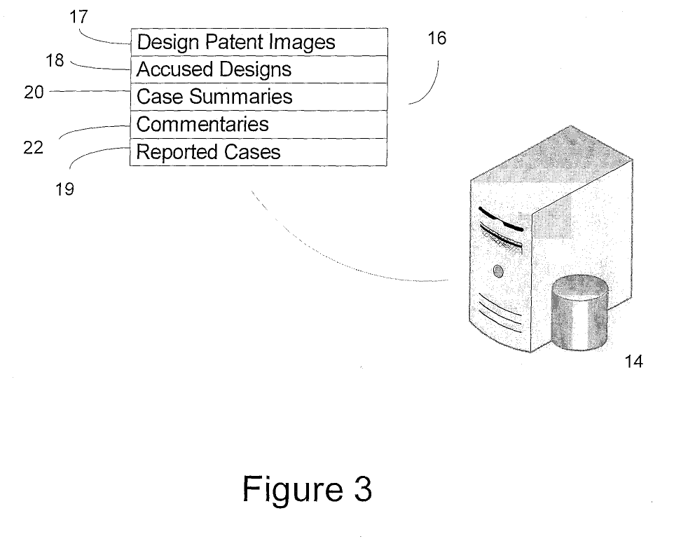

Referring briefly to FIG. 3, database server 14 stores data that comprises images of design patents 17, images of accused designs 18, reported cases/decisions 19, case summaries 20 and commentaries 22. The visual images 17 and 18, reported cases 19 and verbal descriptions 20 and 22 are organized in server 14 in such a manner that will enable all data corresponding to a particular case to be linked together, on demand from an end user, as will be described below.

Referring back to FIG. 2, the visual image data can be assembled in server 14 from several different sources. For example, in connection with design patent infringement cases, one source of design patent images 17 is the publicly available USPTO website 26. U.S. design patents are frequently only a few pages long (e.g., 3-6 pages), and it is not difficult or time-consuming to download electronic copies of complete design patents; they are available at no cost from the PTO website www.uspto.gov.

Obtaining images of the accused designs 18 is more challenging, since, unlike the PTO website 26 for the patented designs, there is no single source for accused design images. In one preferred method, a physical sample of the accused design is purchased in the retail market (assuming, of course, that it can be located). Then, a digital camera 28 can be used to take photographs that would then be stored in server 14. Utilizing this source of accused images 18 has the benefit of greatly reducing potential copyright problems with respect to the future use of the images. Another benefit is that the photographs taken of an accused design can be set up exactly as desired; it is often preferable to match the views of the accused design with the corresponding views of the patented design as they appear in the issued design patent.

Alternatively, one can obtain images of the accused design from the court 24 in which the design patent case was litigated. In the event such images are stored by the court 24 in digital format, they can be directly loaded without substantial modification onto server 14. In the event that such images are analog photographs, they need to be digitized by, e.g., a scanner 30, before being input into database server 14. It is possible that a copyright clearance would have to be obtained for such images of accused designs 18 before being used in the method of the present invention.

Yet another alternate source of visual images of accused designs would be the attorneys 25 who litigated the case. Such attorneys may include lawyers for the patentee or accused infringer. It is more likely that such attorneys 25 would have visual images in digital form, so that they would not have to be scanned, but copyright clearance/permission would still be an issue. Alternatively, attorneys 25 might be able to loan an actual physical sample of the accused design, perhaps an exhibit that was used in court, which could then be photographed by camera 28 as previously described.

The court 24 would also be one source of a digital version of the decision of a particular reported case 19 (FIG. 3). Many reported cases are made freely available on various websites; for example, decisions from the U.S. Court of Appeals for the Federal Circuit are available at www.II.georgetown.edu/federal/judicial/cafed.cfm. Other websites are available to access other court decisions, as is well known.

It is contemplated that the actual reported court decision or case 19 would be complemented by a case summary 20 and a commentary 22. The summary 20 and commentary 22 are preferably drafted, such as at 32 and 34, by an expert in design patent law. These written summaries and commentaries would be uploaded into the database server 14 in the desired format, to be associated with the design patent image 17, accused design 18 and reported case 19 for a particular design patent litigation.

Scanner 30 could also be used to digitize paper documents of the reported case 19, case summary 20 and/or commentary 22, as may be necessary.

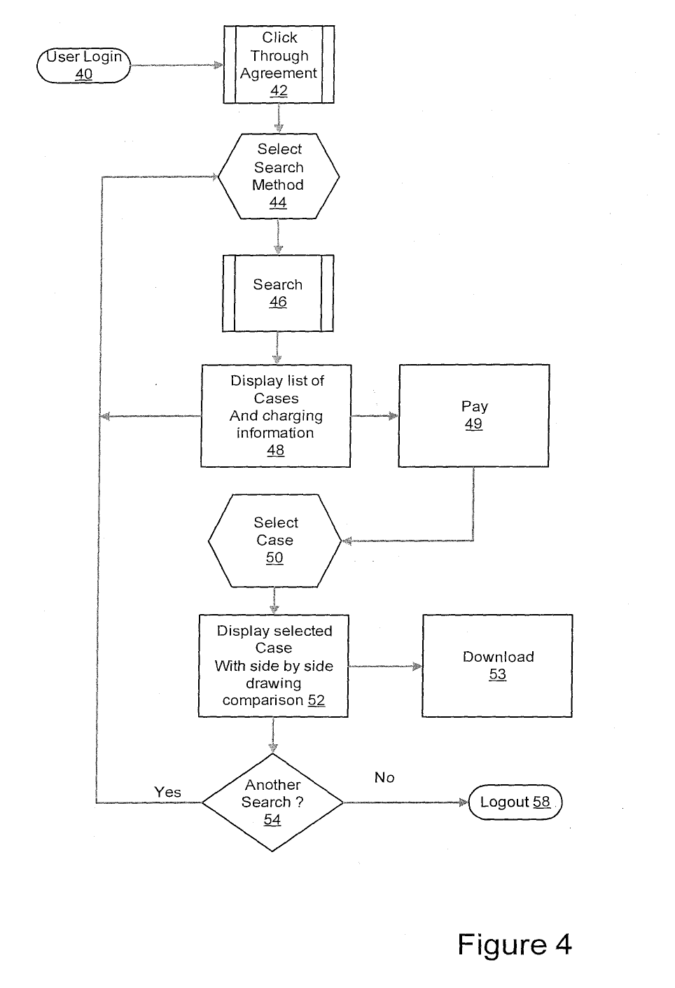

Referring now to FIG. 4, there is illustrated a flowchart showing the interaction of an end user with the e-commerce image-retrieval method of the present invention. Initially, at 40 the user (attorney, designer, judge, law clerk, member of the public, etc.) logs on to the preferred website URL www.designlaw.com, and selects the e-commerce function associated with the image-retrieval method of the present invention. At 42, an agreement is presented to the user by which the user will agree to certain basic terms that will permit limited use and control of the images and data that the user will download. Such basic terms may include, for example, that the user will use the images and other data only for a single purpose, and/or will agree to certain restrictions, e.g., not to disseminate the images and other data to anyone else without permission, or the like. The agreement is preferably in the form of a click-through agreement whereby the user indicates acceptance of the terms by clicking on various spots.

At 44, the user will be presented with a search menu with which the user may select one or perhaps multiple criteria for searching the database 14 for design patent cases. For example, the user might want to see all decisions from a particular court (e.g., the Court of Appeals for the Federal Circuit, or only Federal District Court decisions), and/or only for a particular period of time (e.g., the last 5 years), and/or involving a certain important design patent legal issue (e.g., functionality, obviousness, infringement, on sale bar, double patenting, etc.), and/or a particular stage of a litigation (e.g., rulings on a preliminary injunction motion, Markman determination, motion for summary judgment, etc.), and/or involving a certain type of design (e.g., tires, toys, electronic products, medical devices, consumer products, toothbrushes, etc.).

The search is conducted at 46, and the cases that match the selected criteria are presented on the user's monitor at 48, along with the cost of obtaining the data so selected. If the user wants all data that is displayed, the user then pays the corresponding price at 49. The user will also be able to select certain ones of the cases displayed at 48, and pay accordingly at 49. It is contemplated that block 49 will be able to accept all major credit cards.

At block 48, non-downloadable thumbnails of the patent images 17 and accused designs 18 might appear, along with perhaps a case summary 20, to give the user a glimpse of what is available for purchase.

On the other hand, if the user does not like the search results/cost displayed at 48, and wants to conduct another search, the user can cycle back to block 44 and run another search, presumably based on different criteria.

Once the price is paid at 49, the user can at 50 select one case and have the selected case displayed at 52. For perhaps an extra fee, the user can download the selected case data at 53 in electronic form for use in a brief, opinion letter, or the like.

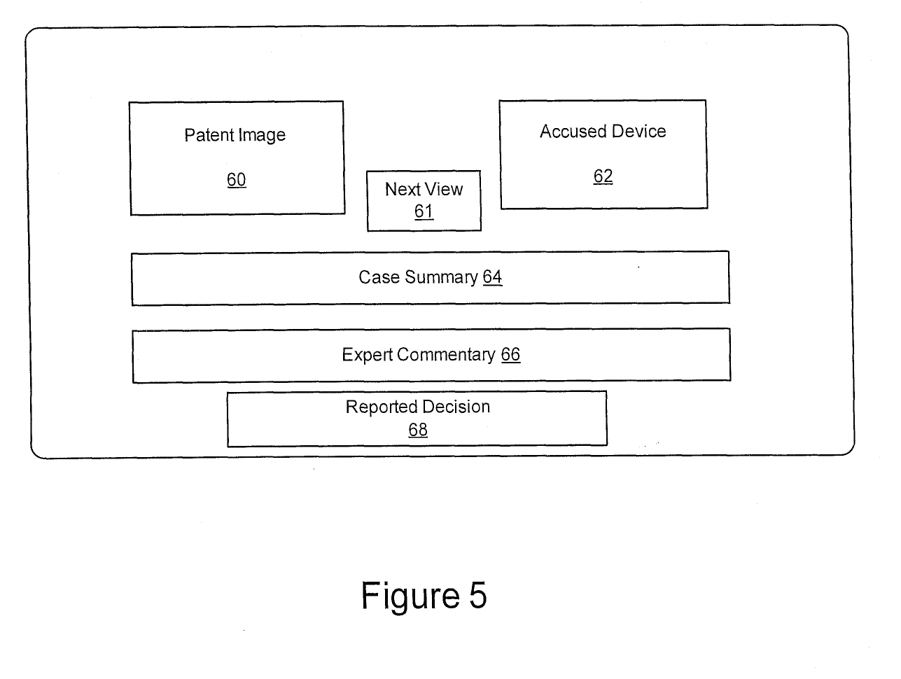

FIG. 5 shows a simplified web page that the user would see at 52. For example, the design patent image 17 could be presented in area 60, preferably side by side at area 62 to the image of the accused design 18. If more than one view of images were available to be compared for a particular case (e.g., front view, side view, perspective view, etc.), then the user could click on box 61 which would activate both areas 60 and 62 simultaneously to bring the next set of images to areas 60 and 62. Alternatively, a plurality of such boxes 61 could be provided, each labeled corresponding to an available view (e.g., front view, top view, left side view, etc) that in turn corresponds to the set of images available to be viewed for a particular case.

Preferably below image areas 60 and 62 are located a case summary area 64 and an expert commentary area 66 in which the corresponding case summary 20 and commentary 22 would appear.

In addition, the user would be able to view and/or download the official reported decision of the case by clicking on box 68.

It is contemplated that additional information may be presented on screen 52, such as related cases, major issues decided, etc.

Referring back to FIG. 4, after displaying, viewing and/or downloading all selected cases at 52, 53, the user may decide either to perform another search at 54 or to logout at 58.

Provision will be also made in the e-commerce method of the present invention for allowing users to subscribe to all reported cases from criteria they would select, e.g., a particular court, a particular issue, particular designs, etc. The relevant data relating to such cases (e.g., patented design, accused design, decision, summary, commentary, etc.) would be automatically sent to subscribers when it became available on database server 14. Subscribers, who would pay a subscription fee, would not need to use the login system of FIG. 4.

Obviously, numerous modifications of this method and system are possible. For example, not all of the resources described in FIG. 1 need be made available through the home page. One or more of the resources (e.g., The Design Protection Association, the e-commerce image-retrieval method) may be established as a separate website entity with its own home page. Other resources in the field of design and law can be added as the need arises.

Further, it should be understood that the simplified structure of the website represented in the drawings should not be limiting, inasmuch as it is representative only, and a more sophisticated website structure and/or architecture is anticipated as the website is constructed.

Although embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method comprising the operations of:
creating a website directed to issues involving design law;
creating a database of images of products and designs involved in various design law litigations; and
offering the database of images of products and designs involved in various design law litigations through the website,
wherein the operation of offering the database of images comprises the operations of:
receiving a selection of a particular design law litigation including textual design law data associated therewith;
associating particular images of products and designs from the database that are referred to in the textual design law data with the particular design law litigation; and
offering the particular images in conjunction with the particular design law litigation.

2. The method of claim 1, wherein the various design law litigations comprise various design patent litigations, and wherein the operation of creating a database of images of products and designs comprises the operation of creating a database of images of patented designs involved in the various design patent litigations and images of accused products involved in the various design patent litigations.

3. The method of claim 2, wherein the operation of offering the database of images comprises the operation of offering the database of images through the website on a fee basis.

4. The method of claim 3, wherein the operation of creating a database of images of accused products comprises the operations of obtaining a sample of the accused products, taking digital photographs of the accused products, and uploading the digital photographs to the website.

5. The method of claim 3, wherein the operation of creating a database of images of accused products comprises the operations of obtaining digital images of the accused products from courts in which the various design patent litigations were conducted, and uploading the digital images to the website.

6. The method of claim 3, wherein the operation of creating a database of images of accused products comprises the operations of obtaining digital images of the accused products from the attorneys involved in the various design patent litigations, and uploading the digital images to the website.

7. The method of claim 2, further comprising the operation of offering a summary of the various design law litigations along with the images of the products and designs.

8. The method of claim 7, further comprising the operation of offering a commentary about the various design law litigations from an expert in design law along with the images of the products and designs.

9. The method of claim 3, wherein the operation of offering the database of images on a fee basis comprises the operation of offering the particular images on a per case basis.

10. The method of claim 3, wherein the operation of offering the database of images on a fee basis comprises the operation of offering the images of products and designs on a subscription basis.

11. The method of claim 1, wherein the operation of associating particular images occurs before the operation of receiving a selection of a particular design law litigation.

12. A method comprising the operations of:
creating a website directed to providing information about litigated design patent cases;
creating a database of images involved in the litigated design patent cases; and
offering the database of images through the website for a fee,
wherein the operation of offering the database of images comprises the operations of:
receiving a selection of a particular litigated design patent case including textual data associated therewith;
associating particular images from the database that are referred to in the textual data with the particular litigated design patent case; and
offering the particular images in conjunction with the particular litigated design patent case.

13. The method of claim 12, wherein the operation of creating a database further includes the operation of collecting data of actual court decisions and opinions in the litigated design patent cases.

14. The method of claim 12, wherein the operation of creating a database of images further includes the operation of collecting image data of patented designs and image data of accused designs.

15. The method of claim 14, wherein the operation of collecting image data of the patented designs includes the operation of obtaining copies of design patents from a patent office website.

16. The method of claim 14, wherein the operation of collecting image data of the accused designs includes the operations of obtaining a physical sample of an accused design and taking digital photographs of the physical sample.

17. The method of claim 14, wherein the operation of collecting image data of the accused designs includes the operations of obtaining photographs of an accused design and scanning the photographs.

18. The method of claim 13, wherein the operation of creating a database further includes the operation of preparing case summaries and commentaries concerning the litigated design patent cases.

19. The method of claim 18, wherein a user, upon selecting the particular litigated design patent case, is able to download the particular images, the particular images including a patented design and an accused design, a reported court decision and opinion, a particular case summary, and a particular commentary concerning the particular litigated design patent case.

20. The method of claim 12, wherein the operation of associating particular images occurs before the operation of receiving a selection of a particular litigated design patent case.

21. An apparatus, comprising:
at least one server computer including an interface for communicating over a computer network; and
at least one database accessible to the at least one server computer, the at least one database including images of patented designs and accused products,
wherein the apparatus is configured to:
provide access to a website directed to providing information about litigated design patent cases; and
provide access to the at least one database including images of patented designs and accused products, wherein the apparatus configured to provide access to the at least one database is configured to:
receive a selection of a particular litigated design patent case including textual data associated therewith;
associate particular images of a patented design and accused product that are referred to in the textual data with the particular litigated design patent case; and
provide the particular images of the patented design and accused product in conjunction with the particular litigated design patent case.

22. The apparatus of claim 21, wherein the wherein the images of patented designs comprise design patent figures.

23. The apparatus of claim 21, wherein the apparatus is configured to provide access to the at least one database for a fee.

24. The apparatus of claim 21, wherein the apparatus is configured to associate the particular images before the apparatus receives the selection of a particular litigated design patent case.
